(19) United States
(12) Patent Application Publication
(10) Pub. No.: US 2004/0206530 A1
(43) Pub. Date: Oct. 21, 2004

(54) Vented riser for protecting conductors

(76) Inventor: Robert A. Mitchell, New London, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/844,986

(22) Filed: May 13, 2004

Related U.S. Application Data
(63) Continuation-in-part of application No. 10/301,457, filed on Nov. 21, 2002.

(51) Int. Cl. H02G 3/04

(52) U.S. Cl. 174/48

(57) ABSTRACT

A vented riser assembly, having a vented riser incorporated into a main riser, to protect and passively cool power conductors housed therein. The riser assembly is vertically attached to an utility pole and operates in chimney-like fashion to cool warmer air within the main riser, that had become heated due to electrical resistance in the power conductor, by drawing cooler ambient air through apertures in the vented riser while passively exhausting warmer air through the top of the main riser. The affect of reducing temperature within the riser system is to increase amperage, which is adversely affected by an increase in temperature.

### CROSS REFERENCE TO RELATED APPLICATION

This application is a continuation-in-part of patent application Ser. No. 10/301,457 filed on Nov. 21, 2002.

### FIELD OF THE INVENTION

The present invention relates generally to an apparatus and method for protecting conductors, and more particularly to a vented riser, attachable to a utility pole, for protecting power conductors disposed along the pole.

### BACKGROUND OF THE INVENTION

Protective housings or risers have been used for several decades to protect electrical wires, such as power conductors, from vandals and environmental damage, and to protect the public from accidental electrocution.

Power conductors are often run underground to an utility pole, then upwards along the pole until it is at a height safely above the public. The power conductor, while underground or extending towards the top of a pole, is generally safe from vandals and animals, and is well situated to ensure the public's safety. However, the portion of the power conductor that is disposed along the pole is inviting for children to grasp and, perhaps, attempt to climb, and for vandals or animals to damage. Such activity has led to injury and even death of individuals, as well as loss of power to the service area.

Past efforts to limit access to power conductors included attaching a protective housing along the length of the pole, thereby providing a protective enclosure through which the conductor extends. The housing proved to be a reasonable solution for protecting the conductor from animals and humans, and vice versa. However, it was discovered that heat created by the conductor, and subsequently trapped within the riser, increased the air temperature within the riser. This increase in air temperature caused a decrease in amperage in the conductor. Consequently, the efficiency of the conductor was reduced.

A conventional method to overcome the reduction in efficiency, is to integrate a vented riser at the bottom of the main riser to allow cooler ambient air to enter and replace the warmer air in the riser. The warmer air, in a chimney-like effect, rises upward in the main riser, exiting through an opening at the top. Accordingly, the conductor is kept cooler and efficiency is maintained.

The vented riser includes a tubular conduit portion having a plurality of enlarged circular apertures for allowing air to pass into the riser, and a conical portion shielding the apertures from objects which could otherwise be forced therein. The shield portion has an enlarged open end for directing air to the circular apertures.

Conventional vented risers have numerous drawbacks due to their configuration and construction. First and foremost, because the shield portion of the conventional riser extends outwardly from the conduit portion, the riser tends to attract attention of individuals and animals whom may be prompted to stuff objects into the shield portion, clogging it. As such, the ventilating purpose of the vented riser is defeated as air cannot pass freely there-through.

Conventional risers are also limited in that they require a surprisingly large amount of assembly, increasing the cost of the riser. For example, the conduit portion of the riser must first be cut and the air holes bored. Thereafter, the protective shield portion is cut, heated, formed, and positioned on the conduit portion. Once positioned, the conduit and shield portions are drilled, glued, welded and pop-riveted together. A further limitation of the conventional riser is its unusual shape, due to the shield portion. Since the vented riser is not symmetric, such risers are not easily stored and transported.

Accordingly, what is needed is a vented riser which effectively allows heat to be passively removed from the main riser. Also needed is a riser having a simple construction that allows for easy transporting and storing, and which can be cost effectively produced. Further needed is a vented riser which blends into its intended environment when in use to avoid attracting attention of individuals or animals.

The applicant is aware of the following U.S. patents relating to wire protecting devices:

| U.S. Pat. No. | Inventor | Issue Date | Title |
|---|---|---|---|
| 6,227,251 B1 | Ahn, et al. | May 8,2001 | WIRE PROTECTING STRUCTURE |
| 4,902,852 | Wuertz | Feb. 20, 1990 | POWERPOLE WIRING CHAMBER |
| 4,665,279 | Ruschkofski, et al. | May 12, 1987 | PROTECTIVE CONTAINER FOR |
| | | | TRANSMISSION CABLE SLICE |
| 4,284,840 | Baker | Aug. 18, 1981 | SERVICE POLE ASSEMBLY |
| 4,178,468 | Jorgensen, et al. | Dec. 12, 1979 | DUCT POST |
| 3,588,314 | Havewala | Jun. 28, 1971 | POLE RISER MEMBER WITH |
| | | | VENTILATION SHIELD |

Ahn, et al, U.S. Pat. No. 6,227,251 B1, discloses a wire protecting structure for connecting a wire to an insulator mounted onto a pole. The protecting structure facilitates reception of the wire therein and prevents exposure of the wire to the insulator. The wire protecting structure includes a longitudinally formed slit which has a width sufficient to allow insertion of the wire into the tube, and the plurality of protrusions formed on the outer surface of the tube. A cover is provided integral with the tube and has a plurality of holes which are adapted to receive the tube protrusions. A mid-portion of the cover is attached to the top portion of the insulator, and elongate binders are wound about the tube and cover to hold the tube and cover to the insulator.

Wuertz, U.S. Pat. No. 4,902,852, discloses a power pole wiring chamber. The power pole is constructed so that an U-shaped body portion forming a power conductor channel extends beyond a similarly shaped portion forming a communications conductor channel. A cover plate and a top plate are provided to close this extended portion to form a wiring chamber. The cover plate has edges which interlock with the edges of the power channel structure, wherein the edges are crimped to form a permanent assembly. The top plate is removable to provide access to the interior of the chamber.

Ruschkofski, et al, U.S. Pat. No. 4,665,279, discloses a protective container for transmission cable splice. The protective container comprises an elongate, cylindrical pipe formed of a high-strength, projectile-resistant material for containing a transmission cable splice package therein. Brackets are provided for attaching the cylindrical pipe through the side of a transmission cable support pole. The cylindrical pipe is oriented with its longitudinal axis generally vertically disposed, and has a projectile, resistant top plate fixed to the top of the pipe in close vertically spaced relation to overlie the top opening and provide a peripheral opening at the top of the pipe for passage of air.

A second generally circular, projectile-resistant bottom plate is removably secured to the bottom of the pipe to close the bottom opening thereof and to provide a radially disposed slot therein for passage of a transmission cable into and out of the pipe. A transverse bolt spanning the diameter of the pipe above the bottom plate supportably retains a transmission cable splice package within the container.

Baker, U.S. Pat. No. 4,284,840, discloses a utility service pole assembly. The service pole has a bottom positionable on a floor of a room, a pole hanger fixed to a ceiling suspension member and a connector there-between which serves to cooperate with the hanger to maintain the service pole in an upright position and also supports the hanger for movement relative to the service pole to automatically compensate for relative movement of the ceiling suspension member and the floor toward and away from each other without lifting or otherwise distorting the service pole.

Jorgensen, et al., U.S. Pat. No. 4,178,468, discloses a duct post assembly that includes a conduit for extending electrical connections from above a suspended ceiling to an outlet receptacle located between a pair of spaced barrier walls in the post. An upper wall on the conduit forms a lower wall of a junction box at the upper end of the post and defines a passage for extending communication wiring through the post to an outlet passage located above the outlet receptacle and the barrier walls. A boot on the lower end of the post optionally receives the plate having prongs to secure the post to carpeting or receives a pad or plate having an adhesive coat to secure the post to smooth flooring.

Havewala, U.S. Pat. No. 3,588,314 teaches a plurality of venting holes wherein the “axis of each hole extends generally transverse to the longitudinal axis of the boot.” The axis of the holes are normal to the axis of the boot. See column 1 line 47 through column 2 line 2. Nowhere in the specification, the drawings, the claims or anywhere else in the '314 disclosure does it say that the apertures (holes) should be located adjacent the pole. The riser as taught by Havewala '314 has a U-shaped cross section. It would therefore be geometrically impossible to locate an aperture of Havewala '314 adjacent the pole, since the boot does not form a closed loop. Furthermore, fails to teach a riser with apertures having an arcuate length less than ½ or ⅓ of the perimeter of the riser.

Monahan et al., U.S. Pat. No. 3,746,776 discloses a resin coated preservative wooden pole, wherein one or more kerfs are cut into the pole for stress relief. A sheilded electrical conduit is placed within one such kerf, and then covered by a filler material restoring the surface of the pole. Because there is no ventilation in the kerf of the resin coated pole, this suffers from the same shortcomings as other prior art. Heat created by the conductor, and subsequently trapped within the riser, increases the temperature of the conduit within the kerf. This increase in temperature causes a decrease in amperage in the conductor. Consequently, the efficiency of the conductor is reduced.

### SUMMARY OF THE INVENTION

The present invention relates to a vented riser assembly comprised of a vented riser incorporated into a main riser, to protect and passively cool power conductors housed therein. The riser assembly operates in chimney-like fashion to cool warmer air within the main riser, that had become heated due to electrical resistance in the power conductor, by drawing cooler ambient air through apertures in the vented riser while passively exhausting warmer air through the top of the main riser. Since amperage is adversely affected by an increase in temperature, reducing the temperature within the riser system improves the efficiency of the conductor.

In the broadest sense, the present invention relates to a riser that includes a body defining a longitudinal first hollow space configured to receive a wire. The first body is provided with a plurality of apertures for allowing ambient air into the hollow space. A dimension of the apertures is limited to about 1/4 inch or less to restrict objects from passing there-through. Preferably, the apertures are elongate and have an arcuate length less than one-half the perimeter of the first body. More preferably, the apertures each have a width of about 1/8 inch.

In the broadest sense, the present invention also relates to an invented riser system having first and second bodies defining a longitudinal hollow space configured to receive a wire. The first body of the riser system is provided with a plurality of apertures. Means are provided for vertically attaching the riser system to a pole. Preferably, the riser system passively exhausts heated air from within the riser system, replacing it with cooler ambient air passively drawn through the apertures. More preferably, the riser system is generally uniform in cross-section, allowing the riser system to blend into its intended environment.

### OBJECTS OF THE INVENTION

The principal object of the present invention is to provide a vented riser for protecting electrical conductors.

Another object of the invention is to provide a vented riser which has a plurality of apertures that allow ambient air into the riser for ventilating heat from the riser.

Another object of the invention is to provide a vented riser having a simple configuration that is easily and cost effectively manufactured.

A further object of the invention is to provide a vented riser having a shape which allows for it to be easily stored and transported.

Another object of the invention is to provide a vented riser that is basic in shape which will avoid attracting attention when the riser is in position on an utility pole.

### BRIEF DESCRIPTION OF THE DRAWINGS

The foregoing and other objects will become more readily apparent by referring to the following detailed description and the appended drawings in which:

FIG. 1 is a side view of a prior art vented riser, incorporated into a main riser, and shown in use attached to a utility pole;

FIG. 2 is a front view of the prior art vented riser of FIG. 1;

FIG. 3 is a side view of the prior art invented riser of FIG. 1;

FIG. 4 is an end view of the prior art vented riser of FIG. 1;

FIG. 5 is a front view of a conduit portion of the prior art riser of FIG. 2, with the shield portion removed, showing air inlet apertures in the conduit portion;

FIG. 6 is a side view of the invented vented riser, incorporated into a main riser, and shown in use attached to an utility pole;

FIG. 7 is a top view of a bracket for securing the invented vented riser to a utility pole, as shown in FIG. 6.

FIG. 8 is a front view of the invented vented riser of FIG. 6;

FIG. 9 is an end view of the invented vented riser of FIG. 6;

FIG. 10 is a rear view of a bracket for securing the invented vented riser of FIG. 6; and

FIG. 10a is a rear view of an alternative embodiment of the invented vented riser, similar to FIG. 10 but having angled apertures.

### DETAILED DESCRIPTION

Riser assemblies are used to protect electrical wires, such as power conductors, from the public, and vice versa. Power conductors are often routed underground until they reach a destined utility pole, such as a telephone pole. The power conductor is then routed from the ground, vertically upwards along the pole, through the riser assembly, until it exits the assembly at a desired height above the ground. The power conductor is generally safe from the public while underground, within the riser assembly, and at a sufficiently high elevation above the ground.

While providing a safety function, it is important that the riser assembly be sufficiently ventilated in order to cool heated air within the assembly to avoid a decrease in amperage in the conductor. That is, electrical resistance in the power conductor generates heat causing the temperature in the air surrounding the conductor to rise. As the air temperature in the riser assembly increases, the amperage of the conductor decreases, reducing the efficiency of the conductor.

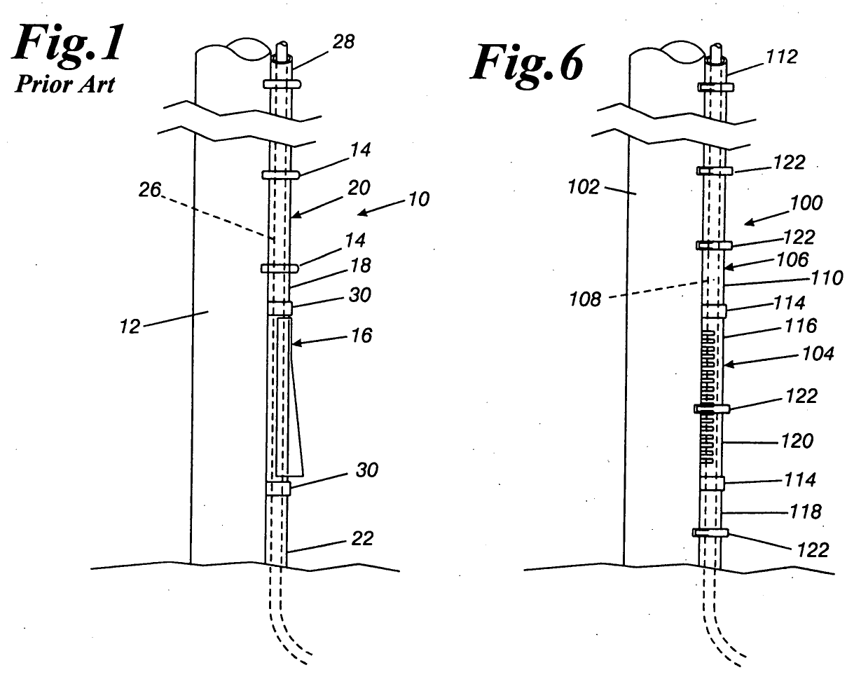

Referring now to the drawings, and particularly to FIG. 1, a prior art riser assembly 10 is shown vertically attached to an utility pole 12 by any standard means, such as a bracket 14 or strap. The riser assembly 10 includes a prior art vented riser 16 attached to the proximal end 18 of a main riser 20. The vented riser 16 is typically at least 6 inches above grade level, with the main riser 20 extending a preselected distance along the pole 12. A separate main riser section 22 may be attached to the proximal end 24 of the vented riser 16 to provide contiguous protection to a power conductor 26 from grade level.

The main riser 20 has a tubular configuration with open proximal and distal ends 18, 28. The proximal end 18 is attached to the vented riser 16 by any conventional means, such as a coupling 30 or forming either the main riser 20 or vented riser 16 with a bell shaped end to facilitate a male-female connection. The open distal end 28 allows for heated air to be exhausted from the riser assembly 10. The main riser 20 may have any suitable diameter, but typically is about 2 to 6 inches in diameter to accommodate the power conductor 26. Preferably, the main riser 20 is made of rigid PVC having sufficient strength to resist impacts and forces.

The vented riser 16 is configured to allow cooler ambient air to enter into the riser assembly 10 while exhausting warmer air, in chimney-like fashion. That is, the warmer air rises within the riser assembly 10 until it exits from the distal end 28 of the main riser 20 while cooler ambient air is drawn into the vented riser 16.

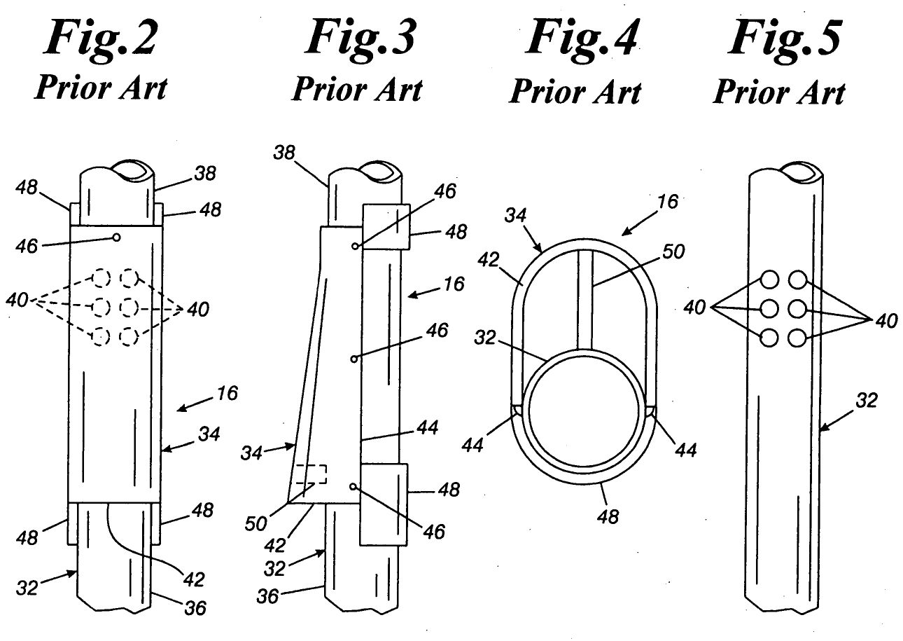

Referring to FIGS. 2-4, the prior art vented riser 16 comprises a tubular portion 32 and a conical shield portion 34. The tubular portion 32 is configured according to similar criteria as the main riser 20. That is, the tubular portion 32 has open proximal and distal ends 36, 38 a diameter sufficient to accommodate the conductor, and is constructed of rigid PVC.

The shield portion is removed in FIG. 5 to shown a plurality of enlarged circular holes 40 provided in the tubular portion 32 for allowing ambient air into the riser assembly. The holes 40 are each greater than one inch in diameter to allow sufficient cool ambient air to be received into the vented riser 16, which subsequently is received into the main riser, cooling the air therein.

Referring collectively to FIGS. 2-4, the enlarged holes 40 in the tubular portion 32 are protected from intrusion of objects by the shield portion 34 of the vented riser 16. The shield portion 34 has a funneled, conic shape with an open proximal end 42 for receiving ambient air. The holes 40 are enlarged and the shield portion 34 funneled in an attempt to compensate for the amount of ambient air flow that is restricted by the shield portion 34.

The shield portion 34 is affixed to the tubular portion 32 by cementing and welding the seams 44 (FIGS. 3 and 4) between the two portions, then securing by a plurality of pins 46 (FIGS. 2 and 3). The pins 46 can be of any suitable type, such as pop rivets, which strongly tie together the shield and tubular portions 34, 32.

Referring to FIGS. 3 and 4, further structural integrity is provided by a pair of braces 48 and a support 50. Each brace 48 is preferably made of PVC sheet, formed into a half circle, and cemented and welded concentrically around the back of the tubular riser portion 32 for added strength. The support 50 extends from the tubular portion periphery 32 to the inner surface of the shield portion 34 forming a rigid support structure there-between against compression.

Referring to FIG. 6, the invented riser assembly 100 is shown vertically attached to a pole 102. The riser assembly 100 includes a simple but novel vented riser 104 attached to a main riser 106. A power conductor 108 is shown, routed underground, and then vertically upwards through the riser assembly 104 until it exits at a desired height along the pole 102.

The main riser 106 is as previously described in the prior art, that is, having a tubular configuration of predetermined length and open proximal and distal ends 110, 112. The proximal end 110 is attached to the vented riser 104 by any conventional means, such as a coupling 114 or providing a bell-shaped end on either the main riser 106 or vented riser 104 to facilitate a male-female connection. The open distal end 112 allows for heated air to exhaust from the riser assembly 100. The main riser 106 may have any suitable diameter, but typically is about 2-6 inches to accommodate the conductor 108. Preferably, the main riser 106 is made of rigid PVC having sufficient strength to resist impacts and forces.

The vented riser 104 is typically at least six inches above grade level, with the main riser 106 extending from the distal end 116 of the vented riser 104 a preselected distance along the pole 102. A main riser section 118 may be attached to the proximal end 120 of the vented riser 104 to provide contiguous protection of the conductor 108 from grade level.

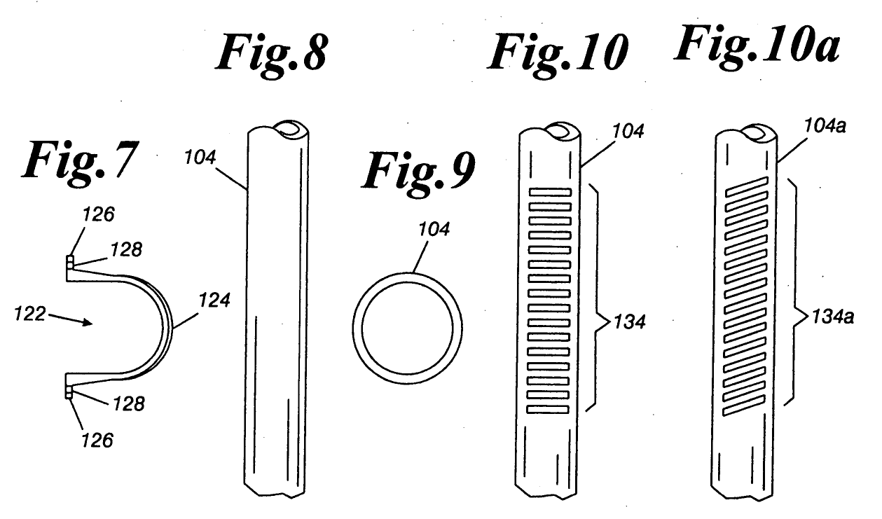

The invented riser assembly 100 can be attached to the pole 102 by any suitable means. However, the preferred attachment means is by utilizing U-shaped brackets 122. As illustrated in FIG. 7, each bracket 122 is configured with an arcuate intermediate portion 124 contoured to fit around the perimeter of the riser, and flanged ears 126, each having an opening 128 through which a mechanical fastener can be applied to affix the bracket 122 to the pole. It is noted, that the vented riser and bracket can be unitary by affixing together by adhesive or the like.

Referring to FIG. 6, the vented riser 104 is preferably configured similar to the main riser 106 to blend the vented riser 104 into its intended environment and, thus, not attract attention (see also FIG. 8 which shows the plain front face of the vented riser 104). Although other configurations can be used, the vented riser 104 is tubular (FIG. 9), having substantially the same diameter as the main riser 106 and capable of housing a conductor 108, and has open proximal and distal ends 120, 116. Although any suitable material may be used, it is preferred that the vented riser 104 be constructed out of rigid PVC, such as Schedule 40 PVC.

Referring to FIG. 10, apertures 134 are provided to allow air into the vented riser 104. The apertures 134 are sized and positioned to allow sufficient air to pass there-through while restricting human fingers or other foreign objects. Although numerous aperture sizes, shapes and arrangements are possible, preferably, the apertures 134 are arranged as a series of narrow slots 134 extending through the wall of the riser, partially around the riser's circumference. Preferably also, the slots 134 extend no more than ½ the circumference, and more preferably no more than ⅓ around the circumference, of the vented riser 104, to maintain structural integrity. Furthermore, an arcuate length of less than ½ of the riser's perimeter is necessary to sufficiently camouflage the riser's vents, and to prevent insertion of foreign objects into the apertures. An arcuate length of less than ⅕ of the riser's perimeter would be inadequate to provide proper ventilation of the riser, and therefore is not preferred. More preferably, the arcuate length should be greater than ¼ of the riser's perimeter in order to ensure the proper ventilation. It is also preferred that the slots 134 have a width no more than 1/4 inch, and more preferably are about 1/8 inch, to restrict items from being forced into the slots 134.

FIG. 10 illustrates the preferred embodiment wherein the slots 134 are radially formed in the vented riser 104. FIG. 10a shows an alternative embodiment wherein the slots 134a are at an angle relative the radial plane of the vented riser 104a. As FIGS. 10 and 10a allude, there are numerous possible arrangements for the slots, so long as the vented riser 104, 104a maintains structural integrity while restricting objects from being inserted therein and while providing ample area through which sufficient ambient air can flow.

Table I shows a preferred aperture area, along with the associated width, length and number of slots, for different diameter vented risers. The vented riser outside diameter is sized according to Iron Pipe Size (ASTM 1784). It is to be noted that the Table merely serves as a guide and is not to be construed as a listing of strict limitations, since varied conductor loadings and environmental conditions would dictate different cumulative area of apertures and/or aperture shape. It is further noted that a plurality of vented risers can be incorporated into a main riser to increase ventilation of the riser assembly.

TABLE I

| Vented Riser Outside | Slot Width | Slot Length | | Cumulative Aperture |
|---|---|---|---|---|
| Diameter (Inch) | (Inches) | (Inch) | Number of Slots | Area (Inch²) |
| 2 | ⅛ | 1.88 | 16 | 3.75 |
| 3 | ⅛ | 3.0 | 20 | 7.5 |
| 4 | ⅛ | 4.0 | 25 | 12.5 |
| 5 | ⅛ | 5.06 | 30 | 19.62 |
| 6 | ⅛ | 6.13 | 38 | 29.09 |

Referring to FIG. 10, the invented vented riser 104 is preferable formed of a rigid PVC material although other material can be used. The PVC vented riser 104 can advantageously be quickly and easily manufactured by an extrusion process or other common manufacturing practice. The slots 134 can be simply formed by a saw cut, or the like. The slots 134 can be cut one at a time, or a plurality of slots 134 can be simultaneously cut by a saw having a plurality of blades.

In use, as shown in FIG. 6, a riser assembly 100 is attached to an utility pole 102 to protect a power conductor 108 that is run along the pole 102, from the public and vice versa. The riser assembly 100 includes a vented riser 104 incorporated into a main riser 106. The vented riser 104 is positioned near the ground, attached to the proximal end 110 of the main riser 106 by standard coupling means 114. The riser assembly 100 is secured to the utility pole 102 by U-shaped brackets 122.

The riser assembly 100 operates in a chimney-like fashion to cool warmer air within the main riser 106 that had become heated due to electrical resistance in the power conductor 108. That is, ambient air is drawn through apertures 134 in the vented riser 104, replacing warmer air that is passively exhausted from the distal end 112 of the main riser 106. Accordingly, amperage, which would otherwise decrease as the temperature around the conductor 108 increases, is maintained.

The vented riser 104 is positioned so that the apertures 134 formed therein are facing the pole 102 in order to further protect the apertures 134 from having objects inserted therein, and to blend the vented riser 104 into the main riser 106. The vented riser 104 has generally the same size and look of the main riser 106, further camouflaging the vented riser 104 into the riser assembly 100. Since the vented riser 104 does not appear unusual, it does not draw unwanted attention from individuals.

### SUMMARY OF THE ACHIEVEMENT OF THE OBJECTS OF THE INVENTION

From the foregoing, it is readily apparent that I have invented an improved riser assembly, comprising a vented riser and a main riser, to protect and passively cool power conductors housed therein. The riser assembly is attached to an utility pole and operates in a chimney-like fashion to cool warmer air within the main riser, that had become heated due to electrical resistance in the power conductor, by drawing cooler ambient air through apertures in the vented riser while passively exhausting warmer air through the top of the main riser. The effect of reducing the temperature within the riser system is to increase amperage, which is adversely affected by an increase in temperature. The apertures of the vented riser are sized to restrict items from being inserted there-through, and the vented riser is configured to be camouflaged into the main riser so to not attract attention of individuals. An arcuate length of less than ½ of the riser's perimeter is necessary to sufficiently camouflage the riser's vents, and to prevent insertion of foreign objects into the apertures.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A housing for protecting a conductor, comprising:
a first tubular body attachable to a utility pole, said tubular body having open first and second ends, and defining a longitudinal first hollow space configured to receive a wire, said first body having a plurality of apertures in one portion thereof for allowing air to pass into said first hollow space, each of said apertures being partially defined by a dimension that is no more than about 1/4 inch, and having an arcuate length less than one-half the perimeter of said first body, and each of said apertures being adapted to face the pole when installed thereon.

2. The housing according to claim 1, wherein said first body is attachable to a second body having first and second ends and defining a longitudinal second hollow space configured to receive the wire, wherein said first and second hollow spaces are contiguous when said first and second bodies are attached together, and wherein said first and second bodies are attachable to a utility pole.

3. The housing according to claim 2, wherein said first body is at a lower elevation than said second body while in operating position on the utility pole, and wherein air within said second body, that is warmer than the ambient air, passively exhausts through the second end of said second body while ambient air is drawn into said apertures of said first body.

4. The housing according to claim 3 wherein said first and second bodies have substantially the same transverse cross-section.

5. The housing according to claim 4 wherein said apertures are elongate and have an arcuate length less than ⅓ the perimeter of said first body.

6. The housing according to claim 5 wherein said apertures have an arcuate length of greater than ⅕ the perimeter of said first body.

7. The housing of according to claim 6 wherein said apertures have an arcuate length of greater than ¼ the perimeter of said first body.

8. The housing according to claim 5 wherein said apertures are radially disposed.

9. The housing according to claim 5 wherein said apertures have a width of about 1/8 inch.

10. The housing according to claim 9 wherein said apertures comprise at least 14 apertures in series.

11. The housing according to claim 9 wherein said first body is cylindrical, and wherein at least six apertures are provided for each inch of diameter of said first body.

12. A riser assembly for receiving and protecting a conductor on a utility pole, comprising:
a first tubular body having open proximal and distal ends, and a plurality of apertures adapted to face the pole when installed thereon;
a second body having open proximal and distal ends;
the distal end of said first body being attached to the proximal end of said second body;
said first and second bodies defining a longitudinal hollow space configured to receive a wire; and
means for attaching said riser assembly to a utility pole with the longitudinal axis of said riser assembly generally vertically oriented.

13. The riser assembly according to claim 12 wherein the cross-section of said first tubular body is generally uniform along its length, and wherein said riser assembly is adapted so that air within said riser assembly that is warmer than ambient air passively exhausts through the distal end of said second body while ambient air is drawn into said first body through said apertures of said first body.

14. The riser assembly according to claim 12 wherein said first and second bodies are cylindrical.

15. The riser assembly according to claim 12 wherein said first and second bodies are made of a rigid PVC.

16. The riser assembly according to claim 12 wherein said plurality of apertures are elongate and radially disposed.

17. The riser assembly according to claim 12 wherein all of said plurality of apertures are elongate and have a width of about 1/8 inch.

18. The riser assembly according to claim 12 wherein said apertures are disposed at least six inches above grade when said riser assembly is attached to the pole.

19. The housing according to claim 12 wherein said apertures are elongate and have an arcuate length of between ⅕ and ⅓ the perimeter of said first body.

20. The housing according to claim 19 wherein said apertures have an arcuate length of between ⅕ and ⅓ the perimeter of said first body.
